(19) United States
(12) Patent Application Publication
(10) Pub. No.: US 2017/0060913 A1
(43) Pub. Date: Mar. 2, 2017

(54) SYSTEM AND METHOD FOR MANAGING SUBSURFACE DATA

(71) Applicant: GEOPLAYGROUND AS, Stavanger (NO)

(72) Inventor: Flemming KJEILEN-EILERTSEN, Randaberg (NO)

(73) Assignee: GeoPlayground AS, Stavanger (NO)

(21) Appl. No.: 15/121,913

(22) PCT Filed: Mar. 26, 2015
(86) PCT No.: PCT/EP2015/056574

§ 371 Date: Aug. 26, 2016

(30) Foreign Application Priority Data
Mar. 26, 2014 (NO) 20140391

(51) Int. Cl. G06F 17/30

(52) U.S. Cl. CPC G06F 17/30303; G06F 17/30592; G06F 17/30371; G06F 17/30368

(57) ABSTRACT

The present invention relates to a system and method for managing subsurface data, creating a knowledge database for containing said subsurface data containing data sets representing data concerning a subsurface feature, and including input means as assumptions and documentation for receiving information regarding data quality related to the subsurface data elements in said knowledge database constituted by a quality factor. Each data set include information related to subsurface features as well as a quality factor related to the data quality of the data representing the subsurface features in each information set. The system also comprising means for evaluating the information for each study area based on the related reliability and to disregard or amend data sets having low reliability

The present invention relates to a system for managing subsurface data, especially geological data, the data being sampled through different processes over time.

Most current technologies are project based, i.e. data are collected and analyzed in several individual software tools within each study. The present solution take advantage of organized and up-to-data databases gathering all data and analytical results in one platform, available for all users and disciplines throughout the study and afterwards. Normally a user need to import/export data from one application to another within different disciplines and get results from e.g. several experts in the organization.

By different defined study areas (geographical polygon) the following system and method described below is allowing a dynamic workflow of data sharing, data analysis, user involvements, documentation and quality assessment to continuously build a knowledge database for a better decision process.

Examples of known solutions are shown EP1921573, WO2002/061462 and WO2003/110087.

EP1921573 refers to a geografic database including data elements. The data elements are evaluated and classified. A visualization is provided and the data are analysed with respect to correlation and control. It does not specifically discuss the introduction and handling of new data into the database. The data elements database is a storage of collection of other data which is just a relation or link to the original source of other data elements that it is derived from.

WO2002/061462 is related to selection of data and how it is distributed to users, while WO2003/110087 relates to a system for collecting seismic data.

The present invention relates to a tool for both data interpretation and management, for generalist and specialist evaluation of (geo-) relevant data and also allows for steps for pre-defined reporting/report templates, review statuses, documentation and approval processes.

Especially it allows collection of data from several technical disciplines and on several different formats into one database platform. The data collection and integration is performed in an automated way, and output parameters can also be defined and generated by an automated solution.

Furthermore, it allows simultaneous use and analysis of the same datasets by several people, both generalists, specialist and management. The system give the users/company the benefit of allocating the resources in an effective way to optimize the different knowledge and expertise of the workers available for a company in the different study areas.

In subsurface evaluation, enormous volumes of data is generated. Such data is needed to perform proper analyses and assessment of risk. A specific subsurface evaluation is normally based on existing, historic data and new data generated for a specific assessment. It is an object of the present invention to utilize these data in a manageable form.

Organizing all sub surface data into its respective stratigraphic divisions and sub-divisions are the key in the organization process that allows for cross discipline integration of data and information and basis for automated, quick and correct analysis performed.

It is also an object of the present invention to provide a robust system that generates easier and more efficient ways of systemizing data, and conduct data analysis and interpretation.

In addition to providing a more complete system to effectively conduct a study in a study area, the present invention also allows building a knowledge database through each consecutive study. It thus provides a tool for managing and controlling different study areas and work where all equivalent data has been incorporated in the assessment, thus the database is being built and extended through each additional study/analysis, gradually building a better and better knowledge database.

The objects of the present invention have been obtained by a system as specified in the accompanying claims.

The system will thus make the exploration value chain more effective and cost efficient. In addition, it will contribute to make the workflow more systematic for the geoscientists in the industries. Huge amount of resources is spent on making presentations, reports posters, etc, but the present invention will make extractions of data into pre-defined table of contents for final document preparation (e.g Microsoft® products o.e). The system will thus improve flexibility amongst technical people in an organization and interaction between the work force regardless of competence and office location.

Thus by improving the technical conditions for control routines, re-use of data and workflow procedures, improved reporting and documentation routines, better availability and use of data. This way the economic advantages are obtained is reduced specialist work-time, more efficient work-flow and the basis for decision is improved from the knowledge database by allowing structured and effective control routines, increased transparency and improved integration.

The strength of the system is the combination of area organization together with the use of multiple stratigraphic types representing the subsurface and this combined with the steps in the approval process to build a growing knowledge database.

The key to the effectiveness is the integration of disciplines in the different modules, all guided by the stratigraphic division and sub-division. The quality control with quality flag and text description fields connected closely to the data enhances the documentation and brings the user assumptions for the analysis to the approval process.

The organization of the system, project areas and modules is designed to best reflect a real work environment in an organization. Employees with different knowledge and expertise in a company is reflected with user roles from interpreters to management level and data administrators. This is designed to take benefit of each others qualifications and the resources available in an organization.

The present invention also relates to making a geographical polygon for storing new analysis data that are not part of the database already to organize the user assumptions and to build knowledge. E.g. plots figures, text descriptions that are done in different Module analysis (disciplines).

According to the present invention a user to define a geographical polygon of an area with additional information (e.g. geographic area, module/discipline information, etc) that these new data in the data analysis are collected from and again is given additional other data sets that builds knowledge (analysis results, documentation, figures, title, descriptions, QF, user info, versions, review status, etc). The polygon creates a working area to add/include and revise knowledge. This knowledge building and revisions of the user versions are based on the user access and roles for the different modules (disciplines) within the geographical polygon. The polygon also controls the area that figures are derived within and the reports that are generated within. The polygon is controlling which tools, filters, trendlines, etc that may be used and be given changes to.

While the abovementioned EP1921573 b) shows a browser for data the present invention is related to how additional data parameters in the database is connected to data already in the database to make it ready for organizing and documenting assumptions to build knowledge to it.

While EP1921573 is making confidence on an established relationship the present invention relates to making quality assurance(Quality Flag-QF) to data parameter(s) and the additional data included.

The present invention may preferably use parametres filtered out based on additional data (e.g. stratigraphic zones/ages, lithologies, facies, etc) to build new knowledge information, e.g. from previous studies having known quality and reliability.

The present invention provides a quality value (flag) on the parametres or the analysis trends that are added/applied to a data/parameter in the database, which may be set through a user interface by a user with the right access and role for the geographical polygon area, or by analysis based on manual quality indication and on documentation regarding, known characteristics of the sampling method used for obtaining the information.

Referring again to WO2002/061462 this is related to selection of data and how it is distributed to users. The present invention is based on making a geographical polygon to where users are given access/roles to do analysis to the new data from a system within the geographical polygon and for the user to make QF to the data to build knowledge related to if the data are to be used in the analysis and to document the assumptions and understanding to include in the analysis figures with title and descriptions and Module (discipline) descriptions etc for building the knowledge. The QF are giving rise to the data elements that are to be used in the figures, plots, trends and analysis results.

The present invention is related to adding users to a geographical area to different Modules/disciplines with same reason as above and explains why not in conflict.

Thus the present invention according to the preferred embodiment of the invention may be summarized as the following process:

A geographical polygon is created to assign users with access and roles to different discipline modules to perform analysis and interpretation and storing the users understanding in a knowledge database for later use and documentation and figures creation in a report.

The polygon defines the access area and the output area for any parametres, data elements and analysis results, documentations (text, figures, etc) and analysis output trend lines and belonging maps.

The database is the collector of all data and data access which the quality assurance is applied to (QF and documentation).

Review process on the QF and analysis (model data) for the analysis results for building knowledge on the interpretation and keeps track of any areas progress and status. Geographical polygon is also controlling the data to be used and the tools for applying new and more data.

1. Polygon controls which analysis are done within each geographical area and additional analysis data (e.g. stratigraphic columns) that are present based on its own stratigraphic constrained geographical polygon.

2. Stratigraphic columns have own geographical polygons for where they can be used/applied.

3. Document categories and belonging elements (documents/reports) have its own geographical polygon

The invention will be described more in detail below with reference to the accompanying drawings illustrating the invention by way of examples.

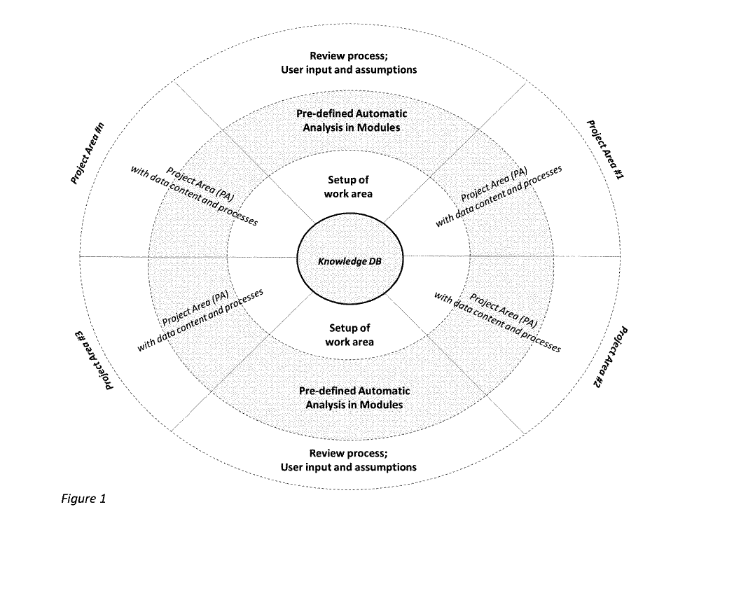

FIG. 1 Illustrates a diagram showing the structure of a company owned database.

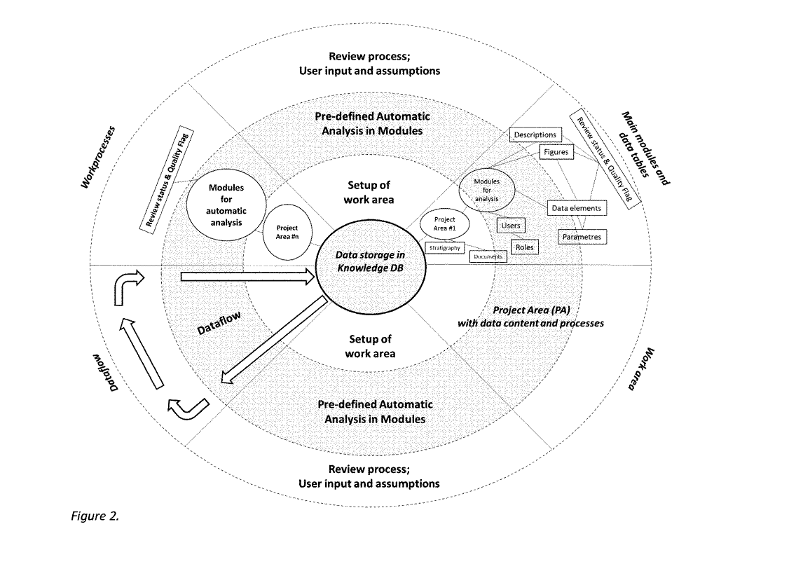

FIG. 2 Is a diagram showing the processes in the system.

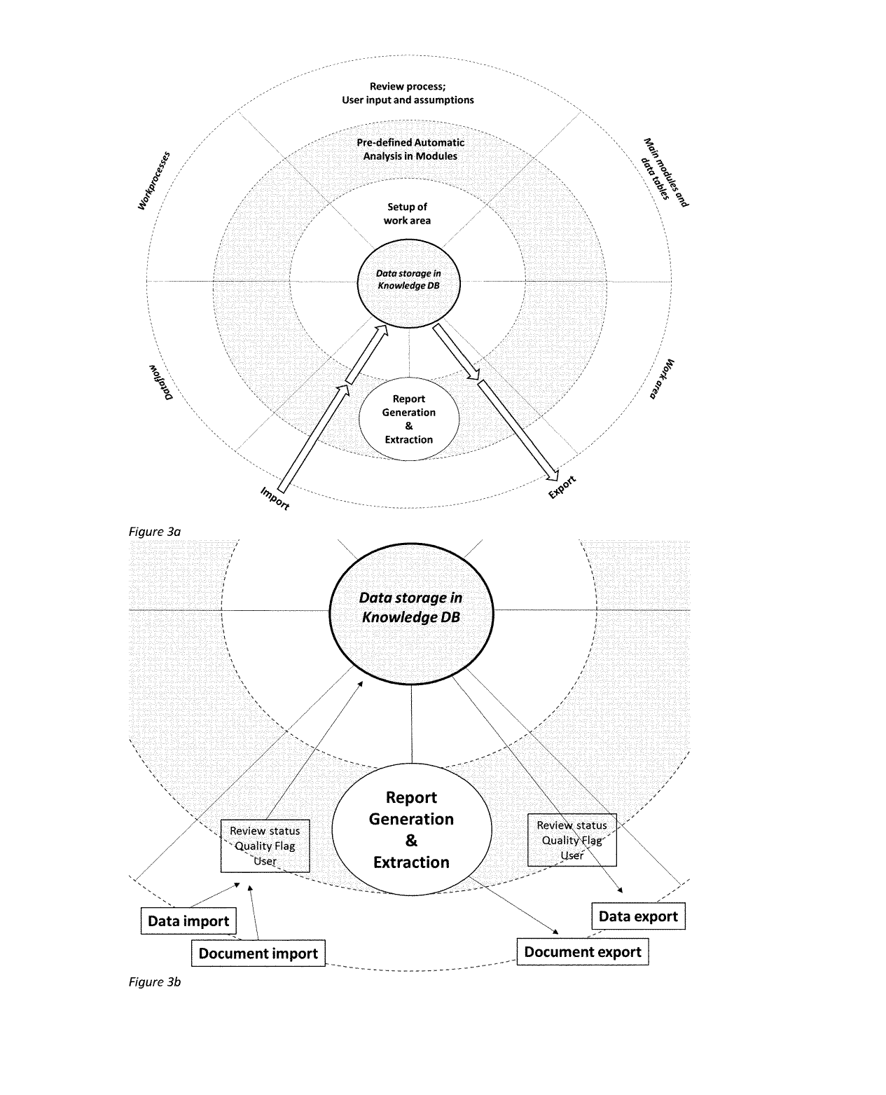

FIG. 3. Is a diagram showing the import/export and report generation in the system.

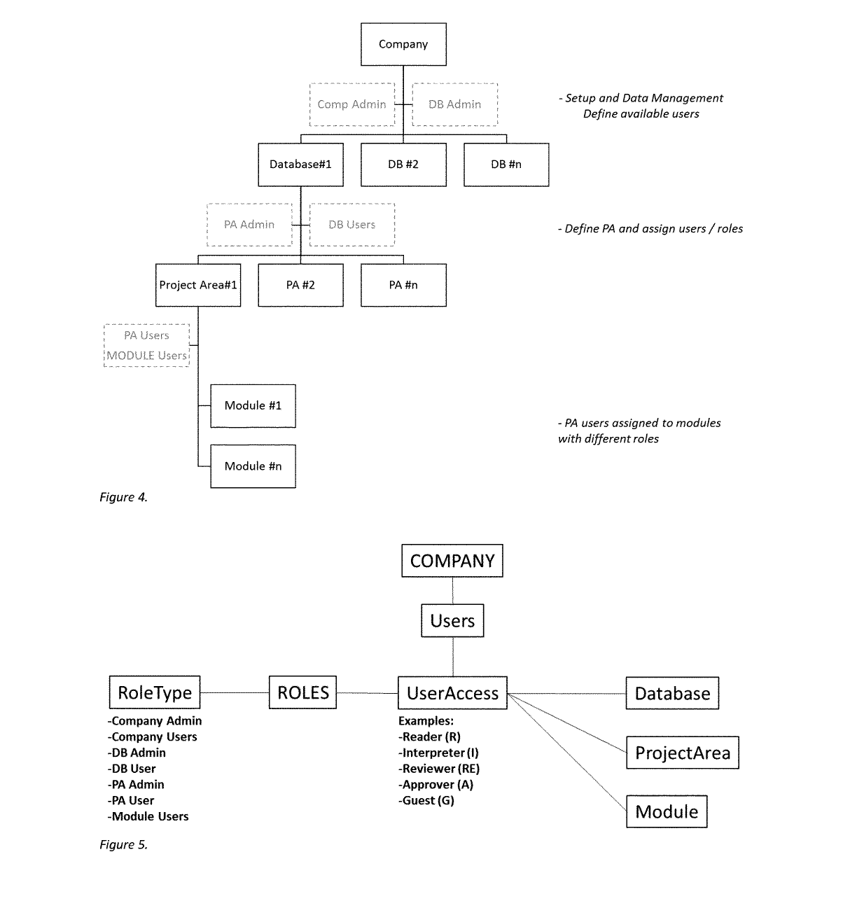

FIG. 4 Is a diagram showing the main administration levels and users level.

FIG. 5 Is a diagram showing the users access definitions with the appropriate roles assignment.

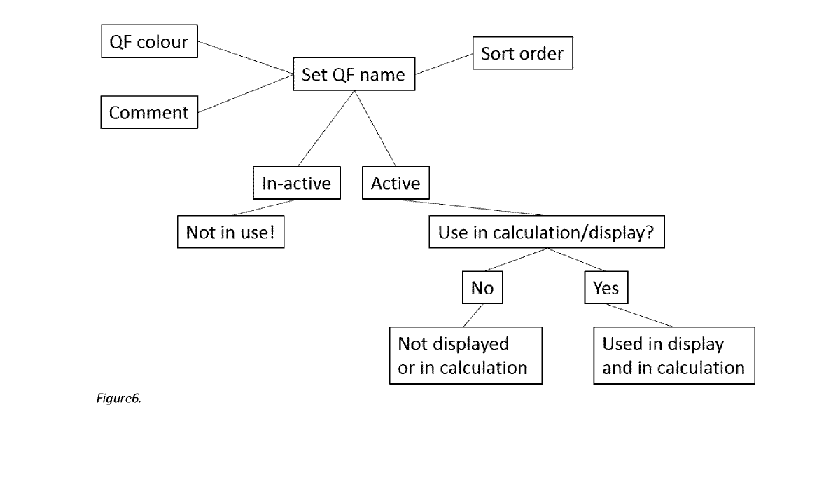

FIG. 6 is a diagram showing the definition of Quality Flag (QF) and the use of it.

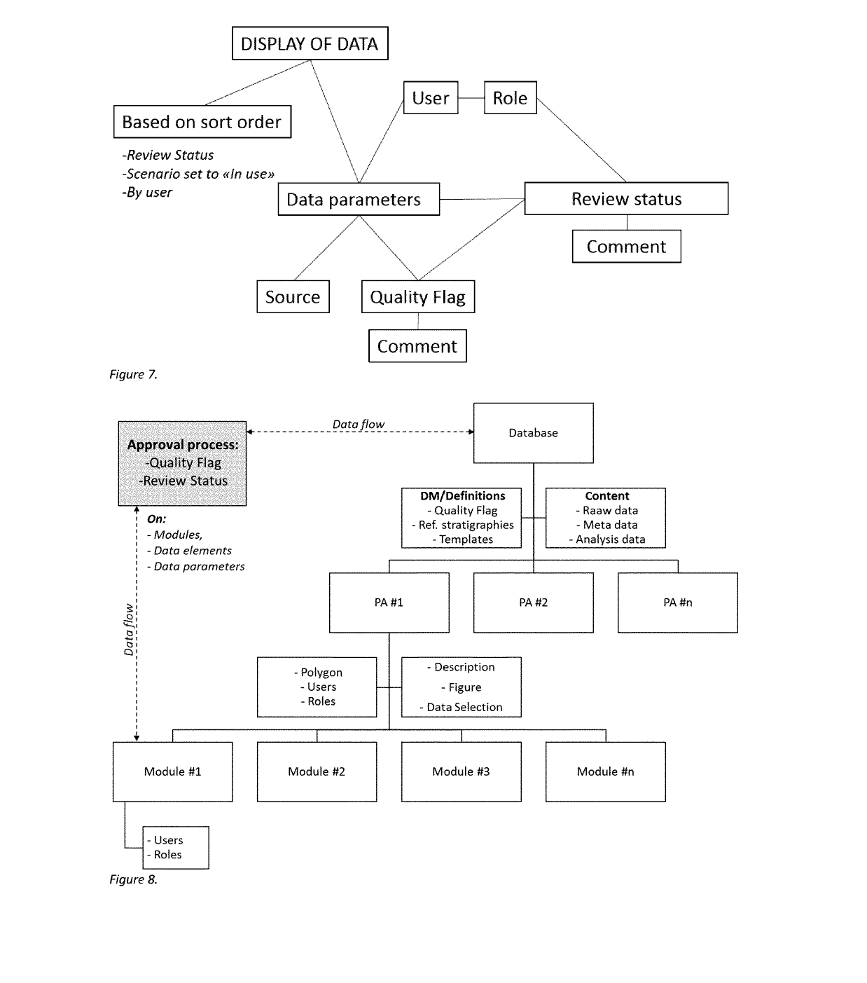

FIG. 7 Is a diagram showing the data structure of how the Quality Flag is set versus the review status in the approval process.

FIG. 8 Is a diagram showing the data structure from the database.

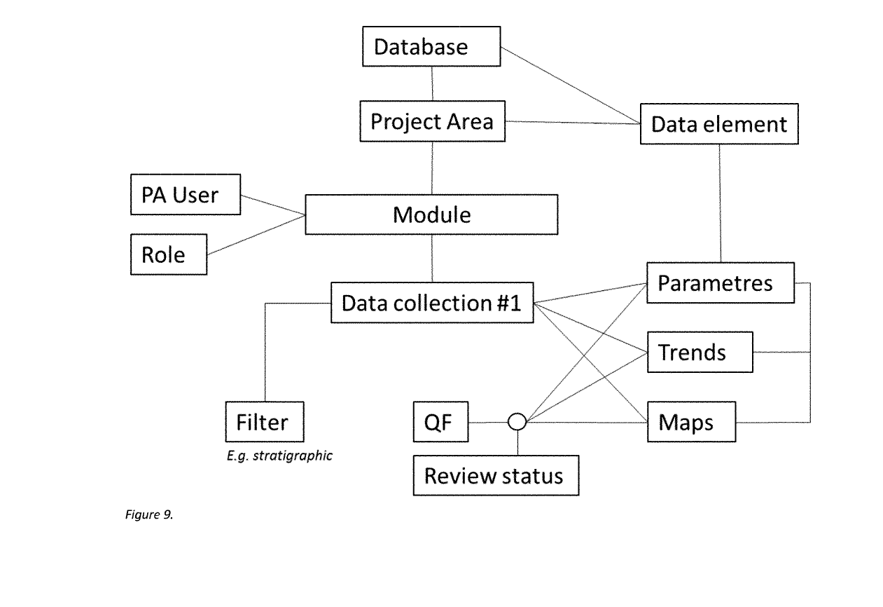

FIG. 9 Is a diagram showing how the Trends data are set and connected.

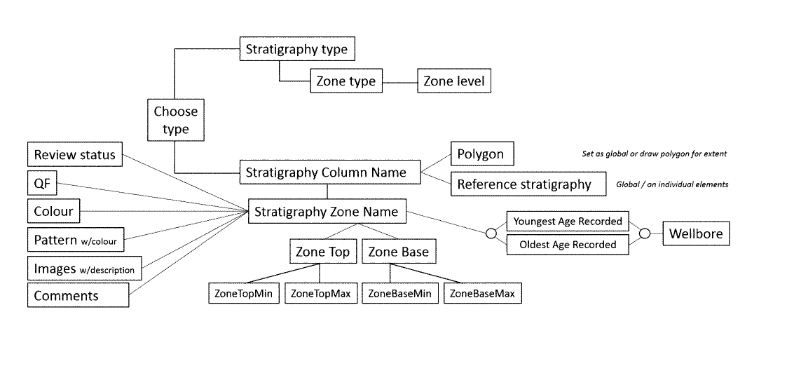

FIG. 10 Is a diagram showing the Stratigraphic Builder.

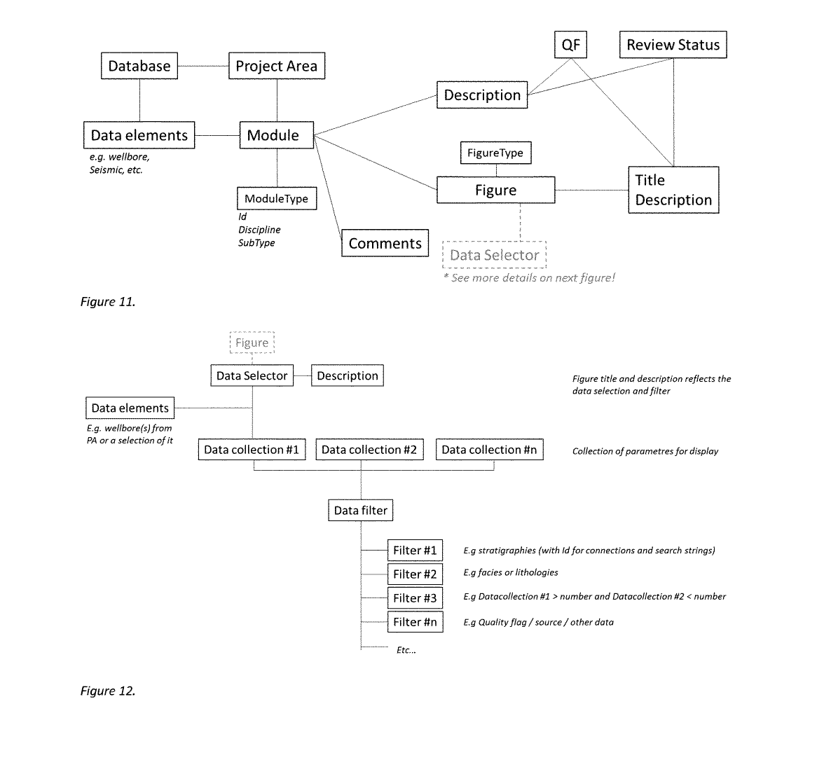

FIG. 11 Illustrates figure title and description organization and connection to the system modules and data elements.

FIG. 12 illustrates the Data Selector.

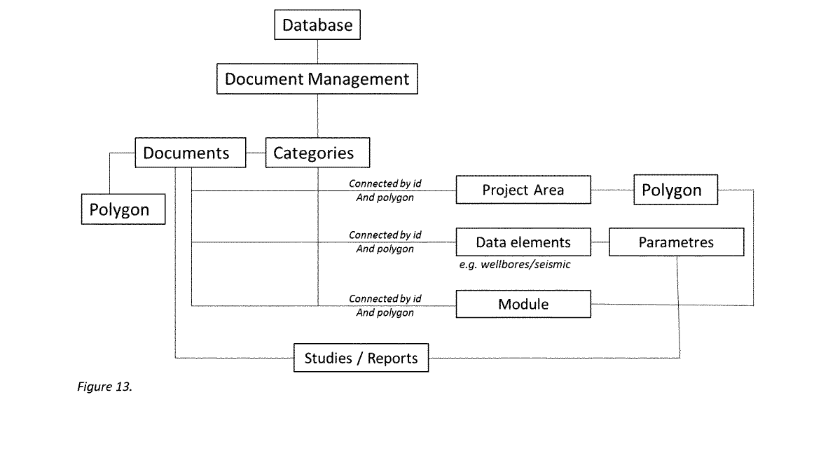

FIG. 13 illustrates the Document Management system.

In general the system according to the invention relates to a hierarchy of elements and data organizations within it as illustrated in FIG. 1, all designed to reflect a real work environment designed to build a growing knowledge database (KnowledgeDB).

### The System According to the Invention

The highest instance is a Company that is the owner of a safe and robust database platform, here called Database (DB) illustrated in FIG. 1. Each Company could have one or several DB's as is illustrated in FIG. 4. Each DB will have its own data management definitions (or selected to have the same as other DB's) for the data in the database and the available resource pool of users available for performing different tasks.

Functions around the DB are organized in layers where “Setup of work areas” are performed, before a layer of “Pre-defined automatic analysis in modules” and outside that a layer with “Review process; User input and assumptions”

Within each DB the companies can manage a number of study areas or Project Areas (PA) (see FIG. 4) constrained areally by a polygon to illustrate the extent of the study area (these polygons may be as big (global) or small as the user/company wants).

From each PA the different analysis will be performed within each of the Modules in the system. A module may be a single well analysis, a selection of wells available for analysis or an evaluation performing an appropriate analysis in the system.

The PA will, based on the defined polygon, have all datasets available (wellbores, seismic, stratigraphies, cultural data, geological data, prospects/leads, fields/discoveries, etc.) either based on the polygon extent or by manual attaching or disabling data belonging to the PA. Thus, the PA defines a study area with the data selection considered relevant for the study by the users/companies. This is possible because all data elements in the DB data storage are individual elements with distinct geographic coordinate information. Update of any data element will be reflected in all PA's covering the geographical location of the data point since the data are stored in the database and not in the individual PA or discipline as is traditionally done.

As stated above FIG. 1 illustrates a diagram showing the structure of a Company owned database. The database is a Knowledge DB with different functional levels for the geographically constrained Project Areas (PA). The functional levels are divided into setup of work areas, pre-defined automatic analysis modules and a review process.

The different work processes within the system setup illustrated in FIG. 1 is shown in FIG. 2, showing a diagram of the processes in the system. The processes are integrated into a seemless system to build a growing Knowledge DB. The different processes are a) workprocesses, b) dataflow, c) Main modules and data tables and d) Work areas. All these processes are integrated into a seamless system that are designed to create a Knowledge DB.

Import and Export functionalities are passing the different processes in the system (FIG. 3a) to maintain the quality control in the data (review process), connection to the right data elements and modules (Analysis modules) in the system and make sure the data is compared to the review process (in the Knowledge DB). Both the import/export and the report generation and extraction need to be connected and compared to the different processes in the system for maintaining the good quality of data going into and out of the system (FIG. 3b).

FIG. 3a-b shows diagrams with the import/export and report generation in the system. All data in and out are passing the different processes defined.

As can be seen in FIG. 2 at the section marked “Main modules and data tables” all data elements, the belonging figures, descriptions, and other parameters which is part of the review and quality assessment are analyzed. This is also illustrated in FIG. 3b where the data import is reviewed along with the documentation.

This way not only the assumed or found quality of the data is considered but also the origin of the data. As an example information about a section of the earth will be assumed to be more reliable if the origin is from a bore hole with registered content than a seismic study of the same section. Thus the related information may follow both in the import and export of the data, as well as being used in the report generation and extraction aiding an operator to understand and possibly adjust the report or information and quality factors based on this.

### Users and Roles

Users are distributed into the PA from the DB administration (resource pool), and will act as the working resources for the PA's as shown in FIG. 4 showing a diagram with the main administration levels and users level definitions in the system architecture. The users will be allocated different roles and responsibilities on the different Modules in the PA based on the individual users expertise.

To setup and administrate the system, administration and user groups need to be defined. A hiearcy with different roles are needed to make sure the right company definitions are set, the right user are set for data management and last the present employee resources in the company need to be distributed as users in the system.

The access is distributed via the UserAccess (FIG. 5) and roles (RoleType) in FIG. 4 to the appropriate Database, Project Area and Modules from the users available in a company, where the PA Users and Module users may relate to the polygos and/or data sets depending on the access.

Several role types are defined to allocate the “correct” user right to handle the system. The needed roles are distributed from company administration to data interpreters/analysts available for the different modules. The role types are:

Company Administration (CompAdmin)

Database Administration (DBadmin)

Database users (DBuser)

ProjectArea Administration (PAadmin)

ProjectArea Users (PAuser)

The Company Administration (CompAdmin) is the company responsible person for the whole system setup and are entitled to create databases (DB) and assign DBadmin for further setup.

The Database Administration (DBadmin) are defining the system and act as a data administrator for definitions setup of system, creates PA's with PAadmin and DBuser.

The Database users (DBuser) are the resource pool for all users in DB and these users are made available for distribution to the PA's.

The Project Area Administration (PAadmin) is the administrator for the PA and assigns PAusers with UserAccess to the modules.

The Project Area Users (PAuser) are made available for selection to modules via the UserAccess to do analysis based on the given rights.

To secure and manage the review process with Quality Flag (QF) on data and a review status to build a KnowledgeDB, different roles and user access need to be set for the different Modules in the system. These users are defined from generalist to specialist or interpreter to reviewers and approvers. The PAuser with administration rights will distribute and assign different roles and user access to users for the individual modules in a PA.

Example of users that can be organized with the following roles:

Reader (R)—Only read access for info

Interpreter (I)—Project team member

Reviewer (RE)—QA team in company

Approver (A)—Project Manager or assigned personell

Guest (G)—Short term external user or for Dataroom use

### Quality Flag

To manage and build a KnowledgeDB, a controlled and consitant definition is required for the companies to set their own Quality Flag (QF) to best describe the status of the individual data parametres and analysis in the system. The level of quality definitions are entirely up to the company. If three levels are appropriate for a given company then three levels can be defined and if another company need e.g. ten levels then it is room for that as well. This is then the basis for the quality of the data available in the approval process. QF can be set on any data parameter and is fed back to the database with a description/comment for why the QF is set.

The QF builder shown in FIG. 6 is designed for the user/company to define their own QF's template. Here the system allows to set the visual QF colour, activation modus and activated if the QF are to be used in calculations on the different modules or if being visible on the different annotations (e.g. x-plot, maps, histograms etc.).

New data will in the system, based on a user and its role, get assigned a Quality Flag based on a set of rules where there is a comparison to already existing data. The rules are quality, visual indications and relevance for usage in the application analysis.

### Approval Process

When the users have been given the right access level and the appropriate role in the system, the approval process can be used to build a growing KnowledgeDB. In the different modules the data is quality controlled, given a Quality Flag (QF) and set to a review status based on the users rights.

### Review Versus Use

The users can set a value and a QF with a comment on a data parameter as a suggestion, while the user with the appropriate rights/authority will approve or reject the suggestion, also with a review comment (FIG. 7). In this way the company can with its resources have a process to quality control all parameters, input data, calculations, results and exported data. To maintain a Knowledge DB a dataset/parameter being exported need the QF, review status and editor following the data out and in again to maintain the knowledge assigned to the data.

A sort/display order is included to both use the approved data in an evaluation, and as a mechanism to use own or other data as alternative suggestion for the review and approval process.

FIG. 7 shows a diagram of the data structure of how the Quality Flag is set versus the review status in the approval process. What data to display and use is set by a sort order by the user to be able to both use the approved dataset or use other suggestions for potentially use a new approved data(set).

The review process is applied to raw-, meta- and analysis data where all reviewed data and status are stored back to the DB database (see FIG. 8). Analysis data, figures, descriptions etc. are also stored on the PA's, giving a connection both from the data in the modules and the PA's back to the database.

Regardless of QF and review status the data is immediately available for any other PA that may use the data and always use the most up to date values and assumptions. The system users are able to take benefit of each others expertise and understanding to build an even better KnowledgeDB for the company.

FIG. 8 is a diagram showing the data structure from the database with the approval process (QF and review status), reference stratigraphies and template definitions. Each Project Areas (PA) are areally constrained by a polygon (study area) with the available users and their role assignment in the PA and analysis modules.

### Trend Data

Each PA will based on the defined polygon, referred to under “review versus use” above and data available (parametres) in it make a Data Collection that represents a good basis for the analysis. The data within the PA is available for the user to set a QF as referred to under “Quality flag” above, based on the users experience or as a data comparison to other data in the PA. The user can then validate/suggest the quality of the data and annotate/describe the reason for the QF set. In this way the PA represents the area that may give the best understanding of data trends (“Trend data”) within it and with the review status/approval process the basis for further analysis is set.

### Trends

The system generated/proposed Trends (trends/values) are available in the analysis for use or for the user to overwrite it. The Trends data will together with the available parameters be the basis for display together or as input to a gridded surface (e.g. map). The parameters, the Trends and the generated maps are collected together in the “Data collection” for further organization and use.

The different user roles are differentiating who are given the analytical suggestion or who undertake the right expertise for the approval prosess (to approve or reject) as illustrated in FIG. 9 showing how the Trends data are set and connected. Any status of the suggested, versus approved Trends is stored in the system to build a growing KnowledgeDB. The strength in this is that all current status, regardless of approved or not, reflects the understanding and this is available even in overlapping PA's. If increased knowledge in one PA it will represent a better knowledge for the next and vice versa.

Each data point, collection of data points, calculations on e.g a single data within a stratigraphic zonation are compared and represents the guide for the (PA) area trends. Based on the single data points (from e.g wells or seismic) a Trend is drawn/set to connect the population of data or line to show the trend/distribution of it. The Trends is available for editing within the PA polygon (or a zonation around the polygon) by the users given the appropriate right in the PA. In this way a Trend for a specific parameter (even a trendline stretching around the earth) are available for new understanding and editing within the PA and other users may take advantage of this understanding in other geographically constrained PA's. In this way local knowledge and updates will be used to improve the regional understanding and maybe most important the users with the knowledge in one area may not necessary be the expert in another area/province.

The QC controlled parameter together with the Trends is the basis for generating a plot of the understanding of the parameter or both goes into as the basis for gridding a map of the data.

### EXAMPLE

For pressure evaluation, individual wellbore pressure data is calibrated towards “real ” measured datapoints giving a.o. the hydrostatic, lithostatic, fracture, fluid indicators and overpressure in the subsurface. Each of these wellbores act as a guide for the regional overview. All datapoints in the PA are basis for the area interpretation and display of results. The result is that the stratigraphic zonations and filters (see the discussion on DisplayTemplate below) will give a “one-to-one” comparison of data that are used as guidance to the pressure model in areas with insufficient data. These guides/default values can be updated with user specified values. Equivalent usage for other data analysis in the system.

### Stratigraphy

To establish study areas for detailed analysis the definition of PA discussed above under the system section is crucial to focus on a selected dataset for an evaluation. Then the users need a set of defined stratigraphies that is appropriate for the area and the stratigraphies to use when analyzing data. This could be wellbore data, seismic interpretation, geological modelling, etc. Main reason is to have control on what the units/zones in the subsurface is representing, but also use the stratigraphies to filter out the appropriate data to speed up the searches and analysis. The diagram in FIG. 10 illustrates the definitions of different stratigraphic types and relations in the Stratigraphic Builder. Stratigraphic definition; a set of zones with age ranges to best describe the age span of a stratigraphic zone in the subsurface.

Wellbore stratigraphy; is the connection of the defined stratigraphy to a depth along the wellbore path.

### Stratigraphic Builder

The Stratigraphic Builder is classified with a stratigraphy type, zone type and zone levels. These types are then available for defining a Stratigraphy column. Each column is geographicly contrained (see Stratigraphic area constrain below) and available for the QF and review process (see QF and review on zones below). The stratigraphies defined are then available to be used as a reference stratigraphy (see the sections on global reference stratigraphy and reference stratigraphy below). The user get with this a dynamic and flexible solution to manage and create new stratigraphies for further evaluation.

The defined stratigraphies are then available for a.o. each wellbore to select a stratigraphic zone and give a depth (zone top and base), giving a robust and unambiguous database for all stratigraphies. The zone name with additional attributes (e.g. age, colour etc) is defined once, in the stratigraphic builder. The stratigraphies are then the filtering mechanism in addition to PA to make the correct analysis and the correct age versus depth relation. In the section below discussing revised age of wellbore below the mechanism to correct the stratigraphic definitions based on the wellbore is introduced.

Example for a Stratigraphy type is e.g. Chronostratigraphy, lithologystratigraphy, sequencestratigraphy, Biostratigraphy etc and zone types for e.g. Lithostratigraphy are Group, Formation, Member, Unit.

### Stratigraphic Area Constrain

Each stratigraphy will have an areal distribution based on a user defined polygon (FIG. 10). This polygon defines the geographic availability for the stratigraphy, and are spatially searchable for any PA covering the same area. Numerous stratigraphies are made by different authors, some stratigraphies are defined for part of the stratigraphy, some are depositional constrained (just valid for smaller areas), some are incomplete, meaning that a robust system is needed to manage what stratigraphy is representing the area of interest the most. The areally constrain on the stratigraphies makes only the appropriate stratigraphies available in any given PA since the system selects the stratigraphies based on the geographicly coordinates setA good guide for the user.

A chronostratigraphy may be valid for a large area, or like a sequencestratigraphy that may be valid for the whole earth. A lithostratigraphy is an example of a stratigraphy that is more areally constrained.

### QF and Review on Zones

Each of the defined stratigraphic zones in a wellbore is available in the review process to be given a review status and a quality flag (QF) (FIG. 10). The QF will act as a guide to the user in the process and is set independent of the status. E.g. a zone may be approved even if the quality is set to bad. For each zone there may be one or several alternatives for the zone. E.g. a zone may be given different top and base ages by one user compared to another user or sources of data. The review process may approve one of them to be used further in the analysis and the others are just alternatives (as also described in in the section relating to the “Review vs use” above).

FIG. 10. Diagram showing the Stratigraphic Builder with definition of stratigraphies and its components with polygon, reference stratigraphies and solution for the varying top and base ages for a zone.

### Varying Zone Ages

Each stratigraphy column consist of many zones. Each zone in the stratigraphy column have a top and a base age to define the age and the length of the period the zone represents (FIG. 10). The age is based on analysis in e.g. wellbores and represents the best knowledge at present time. In nature a stratigraphic zone varies in age along a surface. Therefore is a variation in age captured for a zone top (ZoneTop) and base (ZoneBase) with a distribution for the top with ZoneTopMin and ZoneTopMax in addition to a ZoneBaseMin and ZoneBaseMax for the base of the zone. Normally in the industry the uncertainty is marked with a pluss/minus range around the ZoneTop or ZoneBase.

In each wellbore the defined stratigraphy is connected to the wellbore with top and base depths and in this way establish the depth to age relationship in the well. What zone that is present along the wellbore path and the age of it is a.o. defined by different trace fossils and stratigraphic markers. This information need to be captured and fed back to the stratigraphic definition to better define the zone age with increasing data. Information from each wellbore is fed back to the stratigraphy definition module and made available for alternative interpretation of the age definition as discussed below.

Revised Age from Wellbore

To capture the information or the revised wellbore stratigraphy each zone defined in the wellbore will have “Oldest age recorded” and “Youngest age recorded” (FIG. 10). In this way a workflow is established to capture additional information for potentially “correct” or just support to the stratigraphic definition. This represents a guide to the stratigraphy definition to get the “right” ranges. In the stratigraphic definition a listing of the zone ages is made available for the user to set new ranges based on the new additional information.

### Global Reference Stratigraphy

A global reference stratigraphy is set in the system to have a global connector for all stratigraphies (FIG. 10). This global connector will be the reference stratigraphy for all other local stratigraphies. This makes the stratigraphic correlation excersice very robust and in addition this is a universal filter for input data, analysis results, figures and text even if there are no other stratigraphies defined. Most often a Chronostratigraphy will be used as a global reference, but other stratigraphies may also be used (e.g. sequence stratigraphy).

This global reference stratigraphy is included in the system as the global connector to communicate from area to area and province to province regardless if other stratigraphies are defined.

### Reference Stratigraphy

In addition a reference stratigraphy can be set by the user/company on the individual wellbores, PA's or other analysis modules. This makes it possible to define a preferred stratigraphy to be used on specific dataset and always be connected to a global connector by the global reference stratigraphy. Both the local and the global need is then taken care of in the system.

Reason for using e.g the reference stratigraphy on the wellbores is to automatically in the system be able to display and make calculations based on the preferred stratigraphy. Even with a preferred reference stratigraphy ALL other stratigraphies may be connected as alternative stratigraphies and may also replace the preferred reference stratigraphy if it is regarded as representative.

With reference stratigrapies is meant all sub-surface stratigraphic definitions and sub-division that are built in the system like Chrono, litho, sequence, bio, tectonic event, deposition environment, facies, lithologies, etc.

### Title and Description

Title and descriptions in the system are defined with the purpose to include assumptions and descriptions directly on the analysis modules on the display and even on the data parametres. Meaning that the title, description and assumptions are stored directly with the data in the database. Reports with titles, description and figures are then easy to extract and export from the system.

A module with data and analysis consists of a general module description and figures (displays, x-plot, maps and tables). To be able to capture this information and publish the results (e.g. pdf, html, word) the data (text/figures/tables—Figure type) need to be connected to the correct data holder in the system.

Each Module description represents a text field with the general information around the module analysis and the data within it. The Module description applies to both the PA and the Modules within it. From each Module or analysis a set of figures is generated to reflect the actual evaluation of e.g. plot, map, histogram, tables or eq. Each figure is related to the Module with a link to the appropriate “Data element” (e.g. wellbore or seismic) or to a PA if the analysis represent a PA.

Each module will have descriptions, figures (with title and description) and comments. The quality control and approval prosess with QF and review status are attached to both the module description and the figure. Each figure will have a definition to what figure type it is.

The description and figures are a semi-automatic solution where the user are affecting the text input field while the system controls the connections and bindings to get the correct text to the correct figures and modules in the system (FIG. 11). This is specially illustrated in FIG. 12 where the appropriate filter controls the text input. If the filters are changed the binding to the belonging text will change accordingly.

FIG. 11 illustrates the system text distribution with “Description” and “Figure” connected to the different modules, PA's and data elements (e.g. wellbore, seismic). The figure title and description organization and connection to the system modules and data elements. Note the connection to the “Data Selector”.

Each figure may have a “Data Selector” that controls the content and setting of each figure. More details on this is discussed below.

### Data Selector

A Data Selector is generated to make figures extractions of an analysis or display done on a filtered selection of data and values with belonging title and description (FIG. 12). The appropriate analysis and display with belonging figure title and description is then ready for automatic generation regardless of new or edited data points in the system. The extraction of data for the figure generation need to be controlled to make sure the included text is reflecting the data in use. Different filters (one or many) of stratigraphies, data ranges and display settings is set by the user in the Data Selector.

In FIG. 12 a Data Selector diagram is showing the definition of a selector/filter available for maps, x-plots, correlations and all other figures created. Figures with title and description is then easily available for display and exports.

### EXAMPLE

For e.g. rock-properties the user want to display porosity versus permeability on a plot window or a map with only data from Middle Jurassic, within the Hugin Formation, the Shoreface depositional environment and sandy lithology, for a porosity >15% and permeability >500 mD. Then the user defines the x and y data, adds the different filter, and cut-offs, with the belonging scales. This information is then stored on the Data Selector together with figure title and figure description. The figure with title and description is then stored in the system with all assumptions and ready to be exported to be included in reports or e.g. web pages. Another example is, if a data point in the filtered data collection are given a new QF that should exclude the data from the analysis, then this need to be reflected in the new analysis with the result of a new figure generated. Even with small changes the generated template will always keep the belonging filters and description up to date to easily extract or export new results.

### Document Management

Documents appropriate for the work planned to be performed is available through a Document Management module. This module will by the user/company definitions categorize all documents into an organized structure.

### Document Management

Categories subdividing and organizing the documents (documents, reports, studies, analysis, articles, links, etc.) into its correct discipline or sub-discipline (parent—child) are defined within the DB and PA (FIG. 13). The documents are then connected to the different belonging data elements (e.g. wellbores, seismic o.e.) and PA's by both a manual selected connection or by a geographic polygon. In this way the documents are always made available in the appropriate PA by its geographic location or by the connection to the data element (e.g. wellbore). The documents will be available in the correct PA or data element by the same categorie definition as in the document management module. For the analysis modules the relevant categories are visible.

In FIG. 13 a Document Management system is illustrated showing a diagram of the relation between the documents and the PA, data selection/elements (e.g. wellbores/seismic) and analysis modules.

Examples is like for a pressure module the appropriate pressure documents is available and in a geochemistry module the geochemistry documents are available.

This structure of documents in different formats (e.g. pdf, word, html, url-links, etc) will be connected to the appropriate part in the system. The reports will be available in the different modules eighter connected by the wellbores or the PA defined.

After a wellbore connection the document can be connected to the belonging data or parametres in the data structure (e.g. a rock-properties measurement from a core) giving a very structured and organized system for illustrating the data origin or where it has been used in different studies. From each wellbore, PA or other modules in the system a connection can be attached from this instance back to the documents in the document management module.

To summarize the present invention is aimed at a system for managing subsurface data, especially geological data. The system comprises a knowledge database for containing the subsurface data, including data sets representing information concerning a subsurface feature. The information may relate to composition, such as rock type, fluid content, seismic signatures, age etc. The system also includes input means for receiving or evaluating a quality factor regarding data quality in the data sets, for example indicating whether the measurement providing the data was consider to be reliable, if the data was calculated based on surrounding information or sampled directly within a well. The reliability may be linked to an individual data element or a complete set of data relating to the subsurface stratigraphic feature in the knowledge database or related to the type of data.

This may also be described as a system for managing sub-surface data, comprising a database for containing said subsurface data, and building knowledge information into said database (knowledge database), for which a geographical study area/polygon is selected to represent a specific study area, and where the system automatically selects from the knowledge database the data represented in this polygon.

For each such polygon, specific analysis are conducted on data from the knowledge database, and the data sets from the analysis are stored back into said knowledge database.

The specific analysis are based on quality controlled and documented input data from the knowledge database, said input data can be ranked according to assigned quality status or other filters, the analysis results for each subset of data analysed within each polygon are documented and stored in the knowledge database, said subset of data analysed within each polygon representing data of varying reliability, and with the potential to disregard or amend data sets having low reliability.

Each data set thus includes information related to subsurface features as well as a value related to the data quality of the data representing the subsurface features in each information set. The system also comprising means for evaluating the information for each study area based on the related reliability and to disregard or amend data sets having low reliability, e.g. as a result of new measurements.

As an example a calculated age or composition of a feature may be corrected after a well has been drilled and thus both the information and the quality indicator may be updated. This in turn may provide a possibility to recalculate the stratigraphic map over a subsurface region, where the increased reliability of a dataset and/or the content of the data set, may provide new knowledge of the region. If parts of the stratigraphy in the region used as reference was considered to be uncertain the reference stratigraphy may be updated with more reliable data. In this process new quality factors may also be calculated or introduced based on the surrounding environment data and/or new input from the user.

The system may also include means for visualizing the information, e.g. by indicating the reliability of a data set using a colour code either in a table or in the map showing the calculated geological features.

In order to maintain the control over the information and information quality the input means preferably is provided with access control, e.g. with password or biometric readers, to receive information about user identity and to allow amendments in said data depending on predetermined user rights. A log indicating the update history of a set may also be related to the information in the database.

The user interface for adding information, comments, adjusting quality factors etc as well as for imaging and showing the resulting maps, tables etc may be of any available type based on available tools, and will not be discussed in the present specification.

1. A system for managing subsurface geological data, the system comprising a knowledge database for containing said subsurface data containing data sets representing data concerning a subsurface feature within a study area, and including input means for receiving and including subsurface data regarding said study area from different technical disciplines, including measured stratigraphic data, documentation of origin of said data and a quality factor related to said data into said knowledge database, and wherein the system is adapted to select from the database data representing said study area,
each data set thus including information related to subsurface features as well as a quality factor related to the quality of the data representing the subsurface features in each data set,
the system also comprising analyzing means for disregarding or amending data sets within each study area from different technical disciplines based on comparison of the quality factor in said data sets so as to disregard or amend data sets having low reliability according to said quality factor of the data set.

2. The system according to claim 1, wherein the input means comprise means for receiving and tracking information about user identity and a log indicating the update history of a set may also be related to the information in the database.

3. The system according to claim 1, being adapted to provide analysis of said data in said Knowledge DB and designed for visualize information within it.

4. The system according to claim 1, including means for dynamic recalculation of the stratigraphic information in a study area for the different disciplines based on the data in the Knowledge database and data elements and associated information of a selected reliability, quality factor or review status.

5. The system according to claim 1, including means for recalculating the reliability/quality factor of a data set e.g. based on new data input or new data in the surrounding data sets.

6. The system according to claim h including means for allowing user amendments in said data depending on predetermined user rights.

7. A method for managing subsurface data, using a system comprising a knowledge database for containing said subsurface data containing data sets representing data concerning a subsurface feature, and including input means for receiving information regarding data quality related to the subsurface data elements in said knowledge database constituted by a quality factor, and documentation of the data origin,
wherein each data set include information related to subsurface features as well as a quality factor related to the data quality of the data representing the subsurface features in each information set and documentation of the data origin,
the method comprising a step of evaluating the information for each study area based on the related reliability and origin, and to disregard or amend data sets having low reliability.

8. The method according to claim 7, wherein the input means comprise means for receiving information about user identity and a log indicating the update history of a set may also be related to the information in the database.

9. The method according to claim 7, being adapted to provide analysis of said data in said database for visualizing the information.

10. The method according to claim 7, including means for recalculating the stratigraphic information is a region based on the data sets and data elements having the highest quality factor.

11. The method according to claim 7, including means for recalculating the quality factor of a data set e.g. based on new data in the surrounding data sets.

12. The method according to claim 7 including means for allowing user amendments in said data depending on predetermined user rights.
